(19) United States
(12) Patent Application Publication
(10) Pub. No.: US 2023/0144458 A1
(43) Pub. Date: May 11, 2023

(54) ESTIMATING FACIAL EXPRESSIONS USING FACIAL LANDMARKS

(71) Applicant: NVIDIA Corporation, Santa Clara, CA (US)

(72) Inventors: Alexander Malafeev, Zurich (CH); Shalini De Mello, San Francisco, CA (US); Jaewoo Seo, Kirkland, WA (US); Umar Iqbal, Fremont, CA (US); Koki Nagano, Playa Vista, CA (US); Jan Kautz, Lexington, MA (US); Simon Yuen, Playa Vista, CA (US)

(21) Appl. No.: 18/051,209

(22) Filed: Oct. 31, 2022

Related U.S. Application Data
(60) Provisional application No. 63/276,907, filed on Nov. 8, 2021.

(51) Int. Cl. G06V 40/16; G06V 10/82; G06T 13/40

(52) U.S. Cl. CPC G06V 40/174; G06V 40/171; G06V 40/165; G06V 10/82; G06T 13/40

(57) ABSTRACT

In examples, locations of facial landmarks may be applied to one or more machine learning models (MLMs) to generate output data indicating profiles corresponding to facial expressions, such as facial action coding system (FACS) values. The output data may be used to determine geometry of a model. For example, video frames depicting one or more faces may be analyzed to determine the locations. The facial landmarks may be normalized, then be applied to the MLM(s) to infer the profile(s), which may then be used to animate the mode for expression retargeting from the video. The MLM(s) may include sub-networks that each analyze a set of input data corresponding to a region of the face to determine profiles that correspond to the region. The profiles from the sub-networks, along global locations of facial landmarks may be used by a subsequent network to infer the profiles for the overall face.

### CROSS-REFERENCE TO RELATED APPLICATIONS

This application claims the benefit of U.S. Provisional Application No. 63/276,907, filed on Nov. 8, 2021, which is hereby incorporated by reference in its entirety.

### BACKGROUND

Expression retargeting may include transferring facial expressions from a face in a driving video to an animated character. Accurately determining facial expressions from a 2D video of a face such that the facial expressions can be transferred to drive the animation of a three-dimensional (3D) computer graphics character is a challenging process. For example, it may be challenging to convert the 2D content into a higher dimensionality.

Conventionally, optimization-based approaches have been used for expression retargeting where identity and expression coefficients of a 3D facial morphable model are optimized to obtain a best fit to an observed 3D face in each incoming 2D image of a video. The identity coefficients define a neutral facial expression, and the expression coefficients define a non-neural facial expression relative to the neutral facial expression. However, the optimization-based approaches have difficulty disentangling the identity and expression information, such that much of the expression information is embedded in the identity coefficients—resulting in poor expression estimation and retargeting performance. Additionally, the optimization-based approaches are computationally expensive, requiring an iterative optimization procedure to be applied to each video frame, which can prohibit real-time operation on embedding devices. Further, the optimization-based approaches lack robustness to variations in head poses and noise in RGB images—often resulting in incorrect and noisy estimations.

Facial expression estimation approaches using deep learning have also been developed. These approaches generally perform more robustly in comparison to optimization-based approaches. However, conventional deep learning solutions require inputs from depth cameras. Depth cameras are far less common in commercial use than ordinary RGB webcams. Therefore, facial expression estimation approaches that use deep learning have not been used extensively.

### SUMMARY

Embodiments of the present disclosure relate to estimating facial expressions using facial landmarks. In particular, the disclosure relates to approaches for determining facial expressions from image data using locations of facial landmarks. The disclosure further relates to machine learning architectures for estimating facial expressions.

In contrast to conventional approaches, such as those described above, disclosed approaches may determine facial expressions from image data using locations of facial landmarks. For example, locations of facial landmarks may be applied to one or more machine learning models (MLMs), such as a neural network, which may use the locations to generate output data indicating one or more profiles corresponding to one or more facial expressions, such as facial action coding system (FACS) values. The output data may be used to generate, determine, select, deform, morph, and/or animate one or more models and/or properties thereof. In at least one embodiment, video frames depicting one or more faces may be analyzed to determine the locations of the facial landmarks. The facial landmarks may be normalized, which may include rotating, cropping, and/or scaling the locations. The normalized facial landmarks may be applied to the MLM(s) to infer the profile(s), which may then be used to animate a computer graphics (CG) model for expression retargeting from the video.

In contrast to conventional approaches, aspects of the disclosure further provide machine learning architectures for estimating facial expressions in which different sets of input data sets are analyzed to determine corresponding facial expression data for a face, and the facial expression data is aggregated to determine aggregated facial expression data for the face. For example, a sub-network may analyze a set of input data corresponding to a particular region(s) of the face to determine one or more profiles that correspond to the region(s) of the face. The profiles from the sub-networks, along with other data, such as global locations of facial landmarks may be used by a subsequent network to infer the profiles for the overall face.

### BRIEF DESCRIPTION OF THE DRAWINGS

The present systems and methods for estimating facial expressions using facial landmarks are described in detail below with reference to the attached drawing figures, wherein:

FIG. 1 is a data flow diagram illustrating an example process for estimating facial expressions using facial landmarks, in accordance with at least one embodiment of the present disclosure;

FIG. 2 illustrates an example of locations corresponding to profiles of facial expressions with respect to an image, and an image of a 3D model which may be generated using the profiles, in accordance with some embodiments of the present disclosure;

FIG. 3 illustrates an example of a machine learning architecture for estimating facial expressions, in accordance with some embodiments of the present disclosure;

FIG. 4 is a data flow diagram illustrating an example process for training one or more machine learning models to estimate facial expressions using facial landmarks, in accordance with at least one embodiment of the present disclosure;

FIG. 5 is a flow diagram showing a method for estimating facial expressions using facial landmarks to determine one or more models, in accordance with some embodiments of the present disclosure;

FIG. 6 is a flow diagram showing a method for estimating facial expressions from video data using facial landmarks to animate one or more models, in accordance with some embodiments of the present disclosure;

FIG. 7 is a block diagram of an example computing device suitable for use in implementing some embodiments of the present disclosure; and

FIG. 8 is a block diagram of an example data center suitable for use in implementing some embodiments of the present disclosure.

### DETAILED DESCRIPTION

The present disclosure relates to estimating facial expressions using facial landmarks. In particular, the disclosure relates to approaches for determining facial expressions from image data using locations of facial landmarks. The disclosure further relates to machine learning architectures for estimating facial expressions.

Disclosed approaches may determine facial expressions from image data using locations of facial landmarks. For example, locations of facial landmarks may be applied to one or more machine learning models (MLMs), such as a neural network, which may use the locations to generate output data indicating one or more profiles corresponding to one or more facial expressions, such as facial action coding system (FACS) values. The output data may be used to generate, determine, select, deform, morph, and/or animate one or more models and/or properties thereof. In at least one embodiment, video frames depicting one or more faces may be analyzed to determine the locations of the facial landmarks. The facial landmarks may be normalized, which may include rotating, cropping, and/or scaling the locations. The normalized facial landmarks may be applied to the MLM(s) to infer the profile(s), which may then be used to animate a computer graphics (CG) model, for example, using expression retargeting from the video.

The disclosure further provides machine learning architectures for estimating facial expressions in which different sets of input data sets are analyzed to determine corresponding facial expression data for a face, and the facial expression data is aggregated to determine aggregated facial expression data for the face. For example, a sub-network may analyze a set of input data corresponding to a particular region(s) of the face to determine one or more profiles that correspond to the region(s) of the face. The profiles from the sub-networks, along with other data, such as global locations of facial landmarks may be used by a subsequent network to infer the profiles for the overall face.

The present disclosure provides for approaches that may be used to estimate facial expressions that are extremely fast and capable of executing the entire end-to-end pipeline running at ˜1 ms on commercially available GPUs, enabling real-time and accurate facial expression tracking on embedded devices. Disclosed approaches may use deep learning to perform detailed estimation of a large quantity of FACS values, such as 53 FACS values, enabling realistic facial expression retargeting to animated CG characters, thereby providing estimates over the widest range of facial expressions, including very extreme ones. Moreover, disclosed approach may be used to effectively disentangle identity and expression facial shape information, with high robustness to variations such as head pose and noise in input videos. Further, the disclosure provides for approaches to estimating facial expressions that do not require depth cameras and may only require RGB inputs. While the present disclosure is primarily described in terms of objects that comprise faces, disclosed approaches may be used with objects other than faces (e.g., deformable objects). Further, while the disclosure is primarily described in terms of facial expression retargeting, disclosed approaches may be used for shape retargeting (e.g., to map the structure of a deformable object depicted in an image to a model). Additionally, disclosed approaches may be used for 3D reconstruction of objects other than faces (e.g., using identity coefficients), such as deformable objects.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

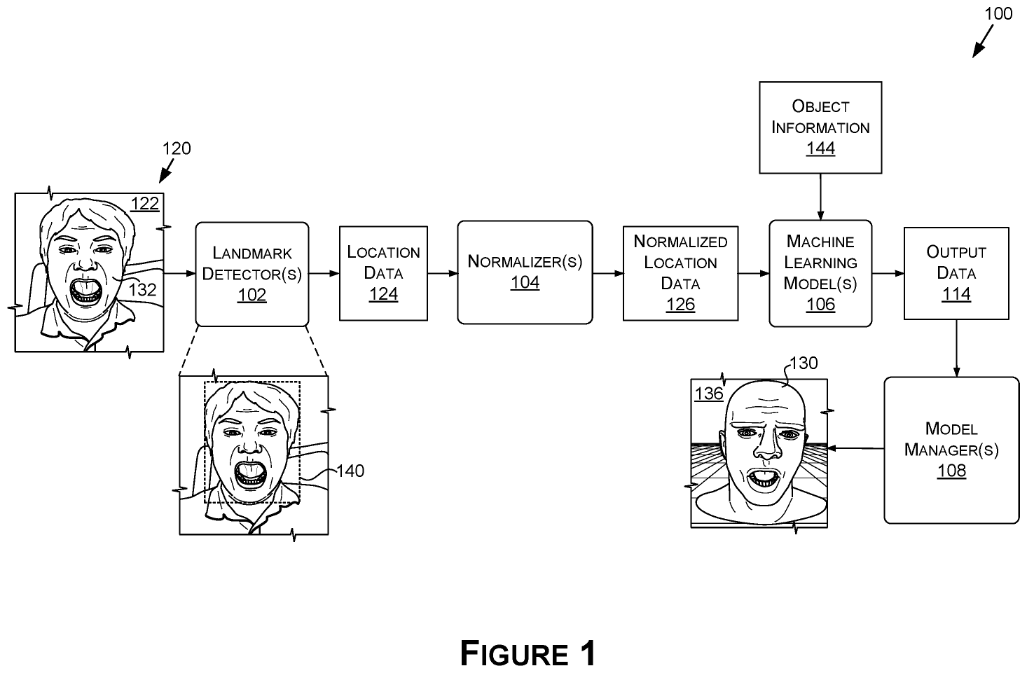

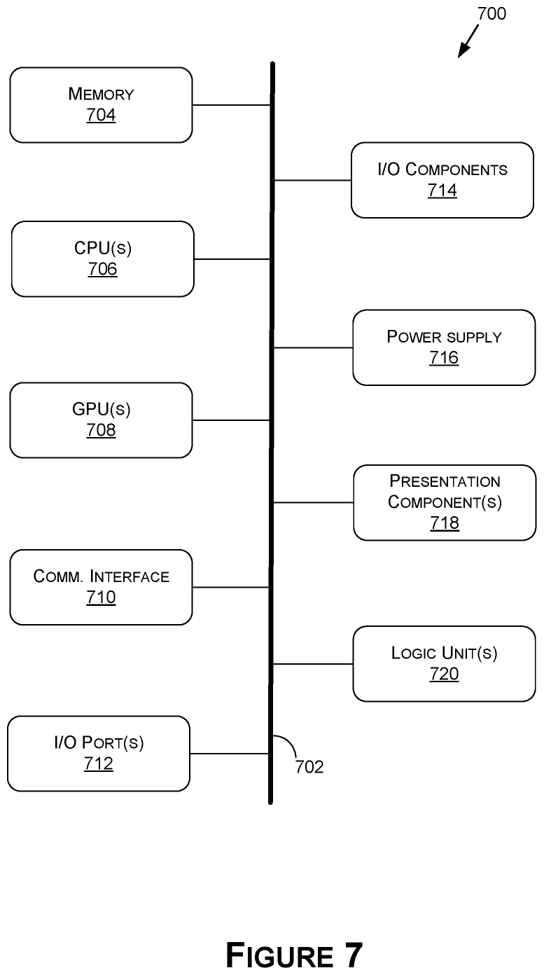

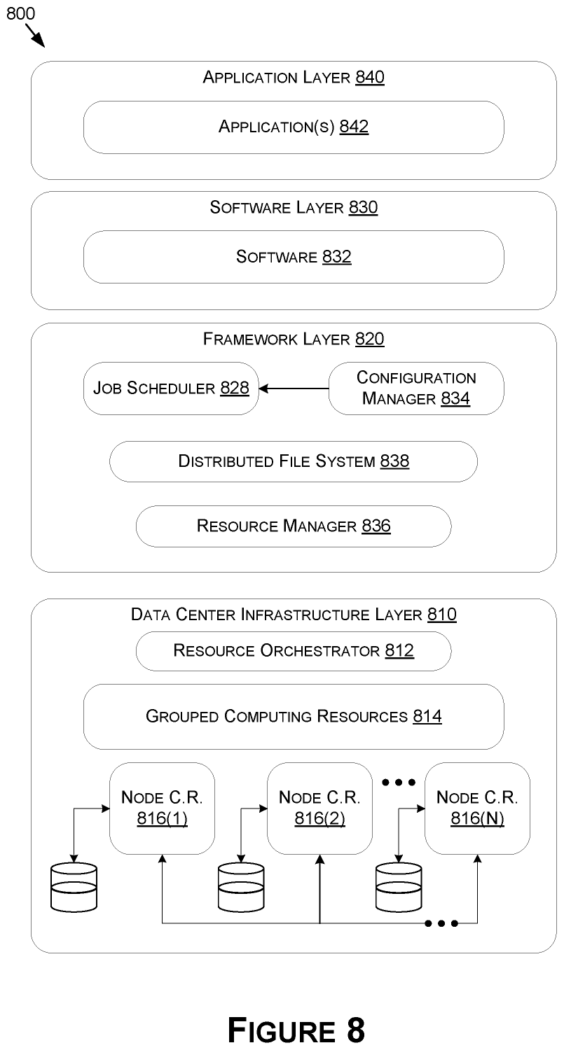

FIG. 1 is a data flow diagram illustrating an example process 100 for estimating facial expressions using facial landmarks, in accordance with at least one embodiment of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In at least one embodiment, the systems, methods, and processes described herein may be executed using similar components, features, and/or functionality to those of example computing device 700 of FIG. 7 and/or example data center 800 of FIG. 8.

The process 100 may be implemented using, among additional or alternative components, one or more landmark detectors 102, one or more normalizers 104, one or more machine learning models (MLMs) 106, and one or more model managers 108.

At a high level, the process 100 may include the landmark detector 102 receiving one or more inputs, such as input data 120 comprising image data representing one or more images 122, and generating one or more outputs, such as location data 124 (e.g., representing one or more locations of one or more facial landmarks for the image(s) 122) from the one or more inputs. The process 100 may also include the normalizer 104 receiving one or more inputs, such as the location data 124, and generating one or more outputs, such as normalized location data 126 (e.g., representing normalized versions of the one or more locations of the one or more facial landmarks) from the one or more inputs. The MLM 106 may receive one or more inputs, such as the normalized location data 126, and generate one or more outputs, such as output data 114 (e.g., representing one or more profiles corresponding to one or more facial expressions) from the one or more inputs. The model manager 108 may receive one or more inputs, such as the output data 114, and generate, determine, select, deform, morph, and/or animate one or more models 130 and/or properties thereof using the one or more inputs (e.g., the one or more profiles). In at least one embodiment, the one or more models 130 are rendered in an image 136.

In at least one embodiment, the input data 120 may include image data, video data, and/or sensor data. For example, where the input data 120 includes image data, the image data may represent one or more images, such as the image(s) 122 shown in FIG. 1. In at least one embodiment, the image(s) 122 may depict one or more portions of one or more objects, such as one or more faces. For example, the image 122 depicts a face 132. The image data may include color information corresponding to pixels of the image(s) 122. By way of example, and not limitation, the color information may be captured using one or more RGB camera. In one or more embodiments, the image data may not include depth information, or the depth information may not be used in the process 100. In one or more embodiments, the image data may include depth information and/or depth information may be used in the process 100.

In at least one embodiment, the image(s) 122 (e.g., a color image) may be represented by image data generated using one or more cameras, such as one or more cameras of a personal computer (PC), a tablet, a smartphone, a laptop, a mobile device, and/or a webcam. The image data may include data representative of images of a field of view of one or more cameras, such as a pinhole camera(s), a stereo camera(s), a wide-view camera(s) (e.g., fisheye cameras), infrared camera(s), surround camera(s) (e.g., 360 degree cameras), long-range and/or mid-range camera(s), and/or other camera types.

In some embodiments, the input data 120 may additionally or alternatively include other types of sensor data, such as LIDAR data from one or more LIDAR sensors, RADAR data from one or more RADAR sensors, audio data from one or more microphones, etc.

In some examples, the image data may be captured in one format (e.g., RCCB, RCCC, RBGC, etc.), and then converted to another format (e.g., by an image processor). In examples, the image data may be provided as input to an image data pre-processor to generate pre-processed image data. Many types of images or formats may be used; for example, compressed images such as in Joint Photographic Experts Group (JPEG), Red Green Blue (RGB), or Luminance/Chrominance (YUV) formats, compressed images as frames stemming from a compressed video format (e.g., H.264/Advanced Video Coding (AVC), H.265/High Efficiency Video Coding (HEVC), VP8, VP9, Alliance for Open Media Video 1 (AV1), Versatile Video Coding (VVC), or any other video compression standard), raw images such as originating from Red Clear Blue (RCCB), Red Clear (RCCC) or other type of imaging sensor. In some examples, different formats and/or resolutions could be used for training the machine learning model(s) than for inferencing (e.g., during deployment of the machine learning model(s)).

In some embodiments, a pre-processing image pipeline may be employed by the image data pre-processor to process a raw image(s) acquired by a sensor(s) (e.g., camera(s)) and included in the image data to produce pre-processed image data which may represent an input image(s) to the input layer(s) (e.g., feature extractor layer(s)) of the machine learning model(s). An example of a suitable pre-processing image pipeline may use a raw RCCB Bayer (e.g., 1-channel) type of image from the sensor and convert that image to a RCB (e.g., 3-channel) planar image stored in Fixed Precision (e.g., 16-bit-per-channel) format. The pre-processing image pipeline may include decompanding, noise reduction, demosaicing, white balancing, histogram computing, and/or adaptive global tone mapping (e.g., in that order, or in an alternative order).

Where noise reduction is employed by the image data pre-processor, it may include bilateral denoising in the Bayer domain. Where demosaicing is employed by the image data pre-processor, it may include bilinear interpolation. Where histogram computing is employed by the image data pre-processor, it may involve computing a histogram for the C channel and may be merged with the decompanding or noise reduction in some examples. Where adaptive global tone mapping is employed by the image data pre-processor, it may include performing an adaptive gamma-log transform. This may include calculating a histogram, getting a mid-tone level, and/or estimating a maximum luminance with the mid-tone level.

The landmark detector 102 may be configured to analyze the image(s) 122 to determine one or more locations (e.g., X, Y locations) of one or more landmarks, which may be represented and/or indicated by the location data 124. By way of example, and not limitation, the landmark detector 102 may be implemented using one or more MLMs. For example and without limitation, any of the various MLMs described herein may include one or more of any type(s) of machine learning model(s), such as a machine learning model using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., one or more auto-encoders, convolutional, recurrent, perceptrons, Long/Short Term Memory (LSTM), Hopfield, Boltzmann, deep belief, deconvolutional, generative adversarial, liquid state machine, etc. neural networks), and/or other types of machine learning model.

As examples, such as where a machine learning model(s) includes at least one convolutional neural network (CNN), the machine learning model(s) may include any number of layers. One or more of the layers may include an input layer. The input layer may hold values associated with an input dataset (e.g., before or after post-processing). For example, when a sample in the input dataset represents an image, the input layer may hold values representative of the raw pixel values of the image(s) as a volume (e.g., a width, a height, and color channels (e.g., RGB), such as 32×32×3).

One or more layers may include convolutional layers. The convolutional layers may compute the output of neurons that are connected to local regions in an input layer, each neuron computing a dot product between their weights and a small region they are connected to in the input volume. A result of the convolutional layers may be another volume, with one of the dimensions based on the number of filters applied (e.g., the width, the height, and the number of filters, such as 32×32×12, if 12 were the number of filters).

One or more of the layers may include a rectified linear unit (ReLU) layer. The ReLU layer(s) may apply an elementwise activation function, such as the max (0, x), thresholding at zero, for example. The resulting volume of a ReLU layer may be the same as the volume of the input of the ReLU layer.

One or more of the layers may include a pooling layer. The pooling layer may perform a down sampling operation along the spatial dimensions (e.g., the height and the width), which may result in a smaller volume than the input of the pooling layer (e.g., 16×16×12 from the 32×32×12 input volume).

One or more of the layers may include one or more fully connected layer(s). Each neuron in the fully connected layer(s) may be connected to each of the neurons in the previous volume. The fully connected layer may compute class scores, and the resulting volume may be 1×1×number of classes. In some examples, the CNN may include a fully connected layer(s) such that the output of one or more of the layers of the CNN may be provided as input to a fully connected layer(s) of the CNN. In some examples, one or more convolutional streams may be implemented by the machine learning model(s), and some or all of the convolutional streams may include a respective fully connected layer(s).

In some non-limiting embodiments, the machine learning model(s) may include a series of convolutional and max pooling layers to facilitate image feature extraction, followed by multi-scale dilated convolutional and up-sampling layers to facilitate global context feature extraction.

Although input layers, convolutional layers, pooling layers, ReLU layers, and fully connected layers are discussed herein with respect to the machine learning model(s), this is not intended to be limiting. For example, additional or alternative layers may be used in the machine learning model(s), such as normalization layers, SoftMax layers, gradient reversal layers, and/or other layer types.

In embodiments where the machine learning model(s) includes a neural network, different orders and/or numbers of the layers of the neural network may be used depending on the embodiment. In other words, the order and number of layers of the machine learning model(s) is not limited to any one architecture.

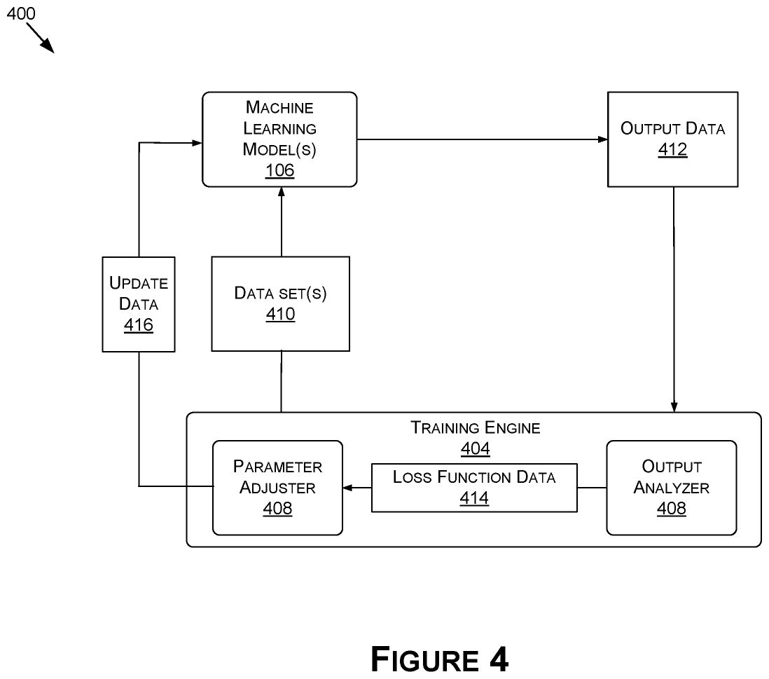

In addition, some of the layers may include parameters (e.g., weights and/or biases), such as the convolutional layers and the fully connected layers, while others may not, such as the ReLU layers and pooling layers. In some examples, the parameters may be learned by the machine learning model(s) during training, such as described with respect to FIG. 4. Further, some of the layers may include additional hyper-parameters (e.g., learning rate, stride, epochs, etc.), such as the convolutional layers, the fully connected layers, and the pooling layers, while other layers may not, such as the ReLU layers. The parameters and hyper-parameters are not to be limited and may differ depending on the embodiment.

In one or more embodiments, the one or more landmarks include fiducial facial landmarks pertaining to the eyes, mouth, nose, face boundary and/or other facial features for each detected face. In one or more embodiments, the number of fiducial facial landmarks may include 126 fiducial facial landmarks, though the exact number of facial landmarks may vary according to various embodiments.

In at least one embodiment, the landmark detector 102 may include at least one object detector configured to detect one or more objects, such as the face 132. For example, the object detector may receive one or more inputs, such the image(s) 122, and generate one or more outputs, such as an object location(s) (e.g., one or more bounding box coordinates and sizes) from the one or more inputs. FIG. 1 shows an example where the object location(s) define a bounding shape 140 for the object (e.g., a bounding box). Where the input data 120 includes video data, the object detection may be performed on each incoming video frame.

In one or more embodiments, object detection may be performed using one or more MLMs, which may be separate from or integrated with one or more MLMs used for detecting the one or more locations of the one or more landmarks. For example, during a first step, the face 132 may be detected. Next, fiducial facial landmarks may be detected for the detected face using the object location(s). In one or more embodiments, the detected object location(s) may be used to crop the image 122, and the cropped image 122 may be analyzed to determine the locations of the landmarks. In one or more embodiments, the image 122 may be analyzed using the detected object location(s) to determine the locations of the landmarks without first cropping the image 122. In one or more embodiments, the object detection and landmark detection may be performed jointly using one or more MLMs.

Next, fiducial facial landmarks may be detected for each detected face. In one or more embodiments, the number of fiducial facial landmarks may comprise 126 fiducial facial landmarks, though the exact number of facial landmarks may vary according to various embodiments.

In addition to or alternatively from analyzing one or more portions of the input data 120 for object landmark detection, the input data 120 may be analyzed (e.g., using one or more MLMs) to determine one or more other properties of the object(s) depicted in the input data 120, such as one or more of an orientation(s) of the object(s) and/or a gaze direction(s) of the object(s). The orientations and/or gaze detection may or may not be implemented in the landmark detector 102 and/or may or may not be used for determining a location of a landmark. For example, image data corresponding to the image(s) 122 may be analyzed to determine a gaze direction of the face 132, such as one or more values representing up/down tilt degrees and one or more values representing left/right tilt degrees with respect to a coordinate system. As a further example, image data corresponding to the image(s) 122 may be analyzed to determine an orientation of the face 132, such as one or more values representing yaw, pitch, and roll with respect to a coordinate system. In one or more embodiments, a perspective endpoint algorithm may be used to estimate the rotation and translation of the head. However, other algorithmic and/or machine learning based approaches may be used.

The normalizer(s) 104 may be configured to analyze the one or more locations of the one or more landmarks to determine normalized version of the one or more locations of the one or more landmarks, which may be represented and/or indicated by the normalized location data 126. In at least one embodiment, the locations of all (e.g., 126) landmarks are normalized. Normalization may include, in accordance with one or more embodiments, one or more of rotating, translating, or scaling of one or more locations of one or more landmarks, such that values of the landmarks all lie in a predetermined range (e.g., −1 to 1).

In at least one embodiment, the rotating may include rotating one or more of the locations of the one or more landmarks in-plane. The normalizer 104 may be configured to perform the rotation to normalize the orientation of the location(s) with respect to a coordinate system. For example, the rotation may rectify the face 132 so that it is straight or otherwise facing a consistent direction across inputs. This may be accomplished, for example, by performing the rotation such that the line joining the two eyes are along the horizontal. In one or more embodiments, the rotation may be performed using the orientation and/or gaze direction determined from the input data 120.

In at least one embodiment, the centering may include centering one or more of the locations of the one or more landmarks about a coordinate system. For example, after the rotation, the normalizer 104 may be configured to determine the centroid of all the locations (e.g., 2D locations) and subtract the centroid from each of the landmarks. This process may effectively change the center of the coordinate system to lie at the centroid of all the given locations. For example, the face 132 may be centered by centering the locations about their mean position. In one or more embodiments, the centering may include subtracting the mean of all the locations. In at least one embodiment, the coordinate system may define the locations with respect to the upper left corner of the bounding shape 140 of the face 132. For example, the upper left corner may be designated as (0, 0) with all locations being relative to that, where X going positive is in the right direction and Y going positive is in the downwards direction.

The normalizer 104 may be configured to perform the rotation to normalize the orientation of the location(s) with respect to a coordinate system. For example, the rotation may rectify the face 132 so that it is straight or otherwise facing a consistent direction across inputs. This may be accomplished, for example, by performing the rotation such that the line joining the two eyes are along the horizontal.

In one or more embodiments, at least some of the normalization may be based on one or more heuristics. In at least one embodiment, one or more locations are centered a predetermined amount (e.g., on a point halfway above) with respect to a location corresponding to a nose of the detected face (e.g., a tip of the nose) on a line joining the location to a point a predetermined amount (e.g., midway) between a center of eyes of the detected face. In at least one embodiment, one or more of the locations may be rotated such that a line joining a predetermined location with respect to a nose of the detected face (e.g., a tip of the nose) to a point is a predetermined distance between a center of eyes of the detected face (e.g., midway between) extends horizontally. In at least one embodiment, one or more of the locations may be scaled such that a distance between a first predetermined location of a first eye of the detected face (e.g., a first eye center of the first eye) and a second predetermined location of a second eye of the detected face (e.g., a second eye center of the second eye) is substantially uniform.

In at least one embodiment, one or more locations are centered on a point with respect to pre-designated landmarks. Furthering this example, the one or more locations are centered halfway above the tip of the nose, on a line joining the tip of the nose to a point midway between the two centers of the two eyes. Next, the one or more locations are rotated such that the line joining the mid points of the two eyes lies along the horizontal and the points are scaled such that the distance between the two eye centers is uniform.

While the normalizer 104 is shown as being separate from the MLM(s) 106 and the landmark detector(s) 102, in one or more embodiments, at least some of the normalization may be performed using the MLM(s) 106 and/or the landmark detector(s) 102. Additionally, or alternatively, at least some of the normalization may not be needed. For example, the one or more locations may be determined using the landmark detector(s) 102 such that they are already centered about their mean or otherwise positioned consistently with respect to a coordinate system.

The MLMs(s) 106 may be configured to analyze the one or more locations of the one or more landmarks to determine one or more profiles corresponding to one or more facial expressions. For example, the MLM(s) 106 may receive the normalized location data 126 as input to generate the output data 114 indicating (e.g., representing) one or more profiles corresponding to one or more facial expressions. In at least one embodiment, all (e.g., 126) of the locations (e.g., X, Y locations) may be input into the MLM(s) 106 to estimate one or more corresponding profiles. In at least one embodiment, the output data 114 indicates (e.g., represents) one or more FACS output values, and/or coefficients corresponding to emotion (e.g., neutral, disgust, happiness, sadness, fear, surprise, anger, etc.), identity, facial albedo, ambient lighting and/or material property information. In at least one embodiment, at least some object information 144 may be input into the MLM(s) 106 to facilitate predictions for one or more of facial albedo, ambient lighting and/or material property information.

While the MLMs(s) 106 are described as analyzing the one or more locations of the one or more landmarks to determine the one or more profiles, additional or alternative object information 144 may be used. Examples of the object information 144 includes data representing the orientation(s) of the object(s) or the gaze direction(s) of the object(s) determined from the image(s) 122, one or more portions of image data (e.g., RGB image data) corresponding to the image(s) 122, and/or temporal information corresponding to the image(s) 122. By way of example, and not limitation, the MLMs(s) 106 may use one or more predictions from one or more previous frames of video to determine one or more predictions for one or more subsequent frames of the video. In at least one embodiment, the MLMs(s) 106 may determine one or more predictions for one or more frames of video relative to one or more predictions from one or more previous frames of the video (e.g., as delta values).

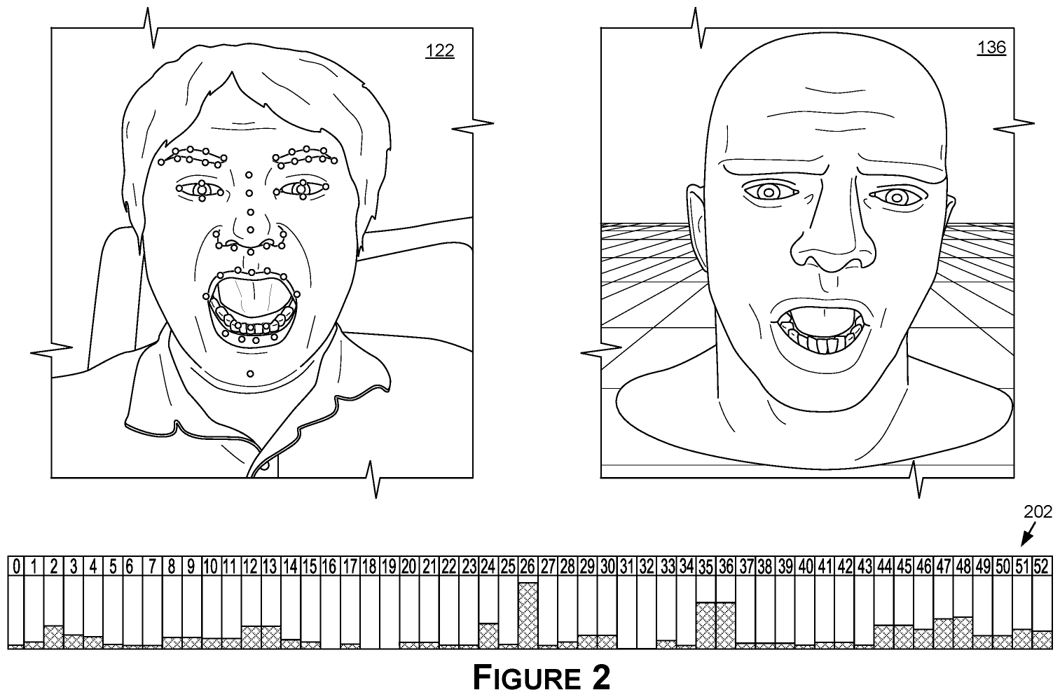

In one or more embodiments, a profile may correspond to one or more facial expressions for one or more portions of the 3D model 136. Examples of the portions of the 3D model 136 include one or more locations and/or regions of the 3D model 136. Examples of such locations and/or regions are indicated in FIG. 2.

Referring now to FIG. 2, FIG. 2 illustrates an example of locations corresponding to profiles of facial expressions with respect to the image 122, and the image 136 of the model 130 which may be generated using the profiles, in accordance with some embodiments of the present disclosure.

In FIG. 2, the locations and/or regions corresponding to profiles of facial expressions are indicated with respect to the image 122 using dots, where each dot may correspond to a respective profile. For example, 53 profiles are indicated in FIG. 2. In at least one embodiment, the MLM(s) 106 may infer one or more values for the profiles.

In one or more embodiments, the one or more values for a profile(s) may specify and/or indicate a presence of at least one facial expression for the location(s) corresponding to the profile. In one or more embodiments, the one or more values for a profile may specify and/or indicate an intensity (e.g., an amount of presence) of at least one facial expression for the location(s) corresponding to the profile.

In at least one embodiment, a profile may correspond to one or more facial movements for the one or more portions of the 3D model 136. For example, the one or more values for a profile may specify and/or indicate a presence and/or intensity (e.g., an amount of presence) of at least one facial movement for the location(s) corresponding to the profile. FIG. 2 shows a graph 202 with each column corresponding to a respective one of the 53 profiles, and the height of the graph corresponding to an intensity (e.g., an amount of presence) of at least one facial movement corresponding to the profile.

By way of example, and not limitation, a profile may correspond to one or more facial action coding system (FACS) values, such as one or more identify coefficients and/or expression coefficients of the 3D model 136. In at least one embodiment, a profile may correspond to one or more action items, such as action units (AUs) and/or action descriptors (ADs). For example, the numbers in the graph 202 may refer to action item numbers or identifiers, such as AU numbers or identifiers. The height of the graph may correspond to the amount of presence of the AU. An AU may correspond to one or more contractions or relaxations of one or more muscles. An AD may differ from an AU in that it is defined independent from a muscular basis for the action.

In at least one embodiment, the model manager 108 may be configured to use information indicated and/or represented by the output data 114, such as at least one of the one or more profiles corresponding to one or more facial expressions to generate, determine, select, deform, morph, and/or animate the one or more models 130 and/or properties thereof using the one or more inputs (e.g., the one or more profiles).

In at least one embodiment, the model manager 108 may determine the geometry for the model 130. The model(s) 130 may include geometry corresponding to the at least one of the one or more profiles corresponding to one or more facial expressions. For example, where a profile corresponds to a facial expression in which the left eyebrow is raised, the geometry for one or more corresponding portions of the model 130 may depict a raised left eyebrow. In at least one embodiment, the model(s) 130 may include geometry corresponding to the intensity indicated by the at least one of the one or more profiles corresponding to one or more facial expressions. For example, where an intensity value for the profile corresponds to a lowest intensity, the geometry may depict the left eyebrow at its lowest position and where the intensity value for the profile corresponds to a highest intensity, the geometry may depict the left eyebrow at its highest position. In at least one embodiment, the intensity indicated by the geometry may be proportional to the intensity value.

There are many ways the model manager 108 may use the output data 114 to determine the model 130 having geometry corresponding to the one or more profiles. In at least one embodiment, a set of weights may be used to blend (e.g., linearly) one or more 3D shapes to create the geometry. In at least one embodiment, in addition to or alternatively from using implicit 3D graphics models, a 3D graphics model(s) may be defined more abstractly, for example, by a CNN(s). In at least one embodiment, a profile may correspond to at least one or more depth values. For example, the MLM(s) 106 may infer at least one or more depth values or deltas to depth values which the model manager 108 may use to determine the geometry. In at least one embodiment, the model manager 108 may determine the geometry for the model 130 using a vector (e.g., latent space vector) inferred by the MLM(s) 106 that has lower dimensionality than the actual geometry of the model 130 and can be used to reproduce more complex geometry by using techniques such as simple linear blending and/or geometry inference using another MLM (e.g., a neural network) and/or algorithmic processing.

In at least one embodiment, each profile, such as each AU, may correspond to a shape deformation definition or morph definition (e.g., for one or more particular regions and/or portions of the model 130). The model manager 108 may use the definition to determine one or more portions of geometry of the model 130 to deform and/or an amount of deformation for the model 130. In at least one embodiment, the amount of deformation may correspond to the intensity for the profile. In at least one embodiment, the amount of deformation my correspond to a delta to a current and/or identity or neutral shape for the model 130. By way of example, and not limitation, the intensity may indicate or represent blend coefficient values (e.g., identity or expression coefficient), which define how the model manager 108 is to blend a shape to produce another shape. In at least one embodiment, the model manager 108 combines (e.g., using a linear combination) weights (e.g., intensity values) for each of the action units inferred from the image(s) 122 and blends the weights (e.g., linearly) of each of the corresponding shape deltas (the expression blend shapes) to determine an aggregated deformation to apply to each vertex of the model 130 in X,Y, and Z dimensions for a portion corresponding to the face 132. The model manager 108 may apply the aggregated deformation to the model 130 to determine the geometry for the model 130. As a further example, the model manager 108 may use one or more profiles to select one or more corresponding predetermined and/or pre-deformed models 130 having corresponding geometry.

In at least one embodiment, the model manager 108 may use the orientation(s) of the object(s) and/or the gaze direction(s) of the object(s) determined from the image(s) 122 to orient or otherwise configure the model(s) 130. For example, the model manager 108 may use an orientation and gaze direction to orient the model(s) 130 with respect to a virtual camera. Facial albedo, ambient lighting, and/or material property information determined from the input data 120 may be applied to the model(s) 130.

In at least one embodiment, the model manager 108 uses the one or more profiles for expression retargeting. For example, the model manager 108 may use the one or more profiles to transfer facial expressions of the face 132 depicted in the image(s) 122 to the model 130. For expression retargeting, the model manager 108 may or may not use identity coefficients (e.g., defining a base shape for the face 132).

In at least one embodiment, the model manager 108 uses the one or more profiles for creating a 3D reconstruction of the face 132. For example, the model manager 108 may use the one or more profiles to determine a base or neutral shape of the face 132 depicted in the image(s) 122 (e.g., for a neutral facial expression). To determine the base shape, the model manager 108 may use identity coefficients (e.g., defining the base shape for the face 132). The base shape may then be modified (e.g., using expression coefficients).

The model 130 as configured using the model manager 108 may be used for various purposes. In at least one embodiment, the model manager 108 may render one or more frames of video depicting the model 130. For example, the model 130 may be rendered to display a video of real-time expression retargeting on the model 130 for the face 132 depicted in a video corresponding to the image(s) 122. For example, the model manager 108 may use the output data 114 to perform expression retargeting of a computer graphics character to drive facial animation and facial re-enactment or for 3D character (e.g., avatar) creation or photo animation. In one or more embodiments, the model(s) 130 may be used for any suitable application that involves 3D models, such as in videogames, movies, live streaming video, computer simulation, television, synthetic data generation for training machine learning models, etc.

Further aspects of the disclosure relate to a machine learning architecture for estimating facial expressions. The machine learning architecture may be used to implement the MLM(s) 106 or one or more other MLMs for estimating facial expressions. While suitable for the MLM(s) 106, in at least one embodiment, the machine learning architecture may be used to implement an MLM(s) that does not estimate facial expressions using locations of landmarks. For example, the MLM(s) may use various types of data such as an orientation(s) of an object(s), a gaze direction(s) of the object(s), one or more portions of image data (e.g., RGB image data) corresponding to the image(s) 122, depth information for the object(s), LIDAR data, RADAR data, sensor data, etc.

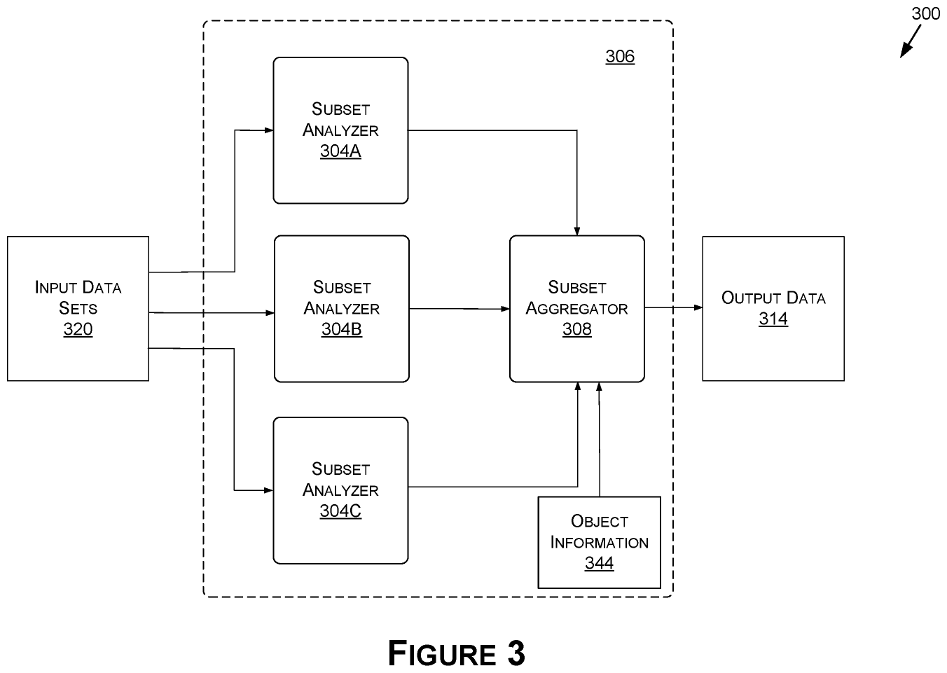

Referring now to FIG. 3, FIG. 3 illustrates an example of a machine learning architecture 300 for estimating facial expressions, in accordance with some embodiments of the present disclosure. The machine learning architecture 300 includes an expression estimator 306 which may analyze input data sets 320 to generate output data 314. In at least one embodiment, the output data 314 corresponds to at least a portion of the output data 114 of FIG. 1. In at least one embodiment, the output data 314 indicates (e.g., represents) one or more FACS output values, and/or coefficients corresponding to identity, facial albedo, ambient lighting, and/or material property information.

In at least one embodiment, the input data sets 320 correspond to the one or more locations of one or more landmarks, as described herein. For example, the input data sets 320 may include sets of the normalized location data 126 corresponding to sets of locations of landmarks. However, the input data sets 320 may additionally or alternatively include sets of other types of information, such as sets of orientations of an object(s), gaze directions of the objects, image data (e.g., RGB image data) corresponding to the image(s) 122, depth information for the object(s), LIDAR data, RADAR data, sensor data, etc.

In at least one embodiment, each set of the input data sets 320 corresponds to a respective subset of input data. A set of the input data sets 320 may be determined based on various potential properties of the portions of the input data to be included in the sets. In at least one embodiment, a set of the input data sets 320 may correspond to one or more respective regions and/or locations of the face 132, the image(s) 122, and/or a corresponding coordinate system. Thus, the set may include a portion of the image data corresponding to the region(s) or location(s). By way of example, and not limitation, where the input data represents or indicates locations of landmarks for the face 132, one data set may include location data corresponding to one or more locations on the left upper half of the face 132 (e.g., including left eye and eyebrow and a center of the nose), another data set may include location data corresponding to one or more locations on right upper half of the face 132 (e.g., including right eye and eyebrow and the center of the nose), and another data set may include location data corresponding to one or more locations on a bottom half of the face 132 (e.g., including the nose below the bridge, the mouth, and the jawline).

Additionally, or alternatively, where the input data sets 320 correspond to image data, one data set may include image data capturing an image region corresponding to the left upper half of the face 132, another data set may include image data corresponding to an image region including the right upper half of the face 132, and another data set may include image data capturing an image region corresponding to a bottom half of the face 132.

Other types of the input data may be similarly grouped into sets. Further, other potential properties used to define the sets include how much deformation has occurred for one or more corresponding landmarks, locations, and/or regions in one or more previous frames. For example, input data may be grouped based at least on ranges of deformation amounts for the corresponding landmarks, locations, and/or regions.

The expression estimator 306 includes one or more subset analyzers, of which subset analyzers 304A, 304B, and 304C (also referred to as “subset analyzers 304”) are shown by way of example. However, the expression estimator 306 may include more or fewer subset analyzers. The expression estimator 306 also includes one or more subset aggregators, of which a subset aggregator 308 is shown.

The subset analyzers 304 are configured to analyze the input data sets 320 to infer facial expression data, such as the one or more profiles corresponding to one or more facial expressions, from one or more sets of the input data sets 320. For example, each subset analyzer 304A may analyze one or more respective sets of the input data sets 320 to determine corresponding facial expression data. In at least one embodiment, each subset analyzer 304 includes a respective MLM(s) and/or a neural network layer(s) trained to infer the facial expression data. In at least one embodiment, the subset analyzers 304 and the subset aggregator(s) 308 form multiple cascaded layers of sub-NNs of the expression estimator 306.

The subset aggregator 308 is configured to aggregate the facial expression data determined using the subset analyzers 304 to determine aggregated facial expression data, such as one or more aggregated profiles corresponding to one or more facial expressions. In at least one embodiment, the subset aggregator includes a respective MLM(s) and/or a neural network layer(s) trained to infer the aggregated facial expression data from the outputs of the subset analyzers 304. The subset aggregator 308 may also analyze object information 344 to determine the aggregated facial expression data. The object information 344 may correspond to a plurality of the sets included in the input data sets 320, such as each set analyzed by the subset analyzers 304. For example, the object information 344 may include information corresponding to the entire face 132 when the subset analyzers 304 analyze input data sets for respective regions of the face 132.

In at least one embodiment, the object information 344 may include any combination of the information described with respect to the object information 144. Additionally, or alternatively, the object information 344 may include at least one of the one or more locations for the one or more landmarks.

In at least one embodiment, the expression estimator 306 corresponds to at least a portion of the MLM(s) 106 of FIG. 1. In at least one embodiment, the expression estimator 306 is a neural network (NN) architecture comprising multiple cascaded layers of sub-NNs. In one or more embodiments, a first layer of networks contains multiple neural networks, each corresponding to a respective subset analyzer 304, that individually processes sub-parts of the face 132. In one or more embodiments, each sub-NN in the first layer takes as input one or more locations of one or more landmarks from a particular facial sub-region. For example, the subset analyzer 304A may take as input a set of the input data sets 320 representing the locations of the landmarks pertaining to the left half of the face 132 only and predict one or more corresponding FACS values for a subset of the FACS that pertain to the left half of the face 132 only.

Furthering this non-limiting example, the subset analyzer 304B may take as input a set of the input data sets 320 representing the locations of the landmarks pertaining to the right half of the face 132 only and predict one or more corresponding FACS values for a subset of the FACS that pertain to the left half of the face 132 only. Also, the subset analyzer 304C may take as input a set of the input data sets 320 representing the locations of the landmarks pertaining to the bottom of the face 132 only and predict one or more corresponding FACS values for a subset of the FACS that pertain to the bottom of the face 132 only.

In one or more embodiments, following the first layer sub-NNs is a single final NN layer corresponding to the subset aggregator 308, which takes as input the (X, Y) locations of the original (e.g., 126) facial fiducial points along with all FACS values estimated by the first layer sub-NNs, and it produces the final (e.g., 53) FACS output values.

In at least one embodiment, the regions and/or locations analyzed by the subset analyzers 304 at least partially overlap. For example, where the subset analyzers 304 analyze locations of landmarks, respective regions may share a border of locations of landmarks or otherwise analyze at least one common location and/or landmark. As a further example, where the subset analyzers 304 analyze image data representing image regions, respective image regions may share a border of one or more pixels or otherwise analyze image data corresponding to at least one common pixel. By way of example, and not limitation, where the subset analyzer 304A analyzes a set of the input data sets 320 representing the locations of the landmarks pertaining to the left half of the face 132 and the subset analyzer 304B analyzes a set of the input data sets 320 representing the locations of the landmarks pertaining to the right half of the face 132, the sets may share in common at least some of the landmarks that run along the nose bridge (e.g., along a border of the regions). Providing overlap in the input data sets 320 may help regularize the data by making the data that is analyzed by a particular subset analyzer 304 less localized.

Referring now to FIG. 4, FIG. 4 is a data flow diagram illustrating an example process 400 for training the MLM(s) 106 to estimate facial expressions using facial landmarks, in accordance with at least one embodiment of the present disclosure.

The process 400 may be implemented using, among other components, one or more machine learning models (MLMs) 106 and a training engine 404. The training engine 404 may include a parameter adjuster 406 and an output analyzer 408. The process 400 (and the components and/or features thereof) may be implemented using one or more computing devices, such as the computing device 700 of FIG. 7 and/or one or more data centers, such as the data center 800 of FIG. 8, described in more detail below.

At a high level, the process 400 may include the MLM(s) 106 receiving one or more inputs, such as one or more samples of a dataset(s) 410 (e.g., a training dataset), and generating one or more outputs, such as output data 412 (e.g., tensor data) from the one or more inputs. As indicated in FIG. 4, the dataset(s) 410 may be applied to the MLM(s) 106 by the training engine 404. The process 400 may also include the output analyzer 408 of the training engine 404 receiving one or more inputs, such as the output data 412, and generating one or more outputs, such as loss function data 414 (e.g., representing one or more losses for the one or more MLMs 106 with respect to one or more cost functions) from the one or more inputs. The parameter adjuster 406 may receive one or more inputs, such as the loss function data 414, and generate one or more outputs, such as update data 416 (e.g., representing updates to one or more values of one or more parameters of one or more of the MLM 106) from the one or more inputs. The parameter adjuster 406 may apply the update data 416 to the MLM(s) 106 to update one or more values of one or more parameters of one or more of the MLM 106 according to the update data 416. The process 400 may repeat any number of iterations, for example, until the MLM 106 is fully trained. For example, the training engine 404 may determine to end training using any suitable approach, such as determining the MLM(s) 106 has converged (e.g., using the loss function data 414), determining a threshold number of training iterations have occurred, etc. The MLM(s) 106 may be deployed and/or subjected to additional verification, testing, and/or adaptation based at least on the determination.

The dataset(s) 410 may include training, verification, or testing data. For example, the dataset 410 may be used by the training engine 404 for training the MLM(s) 106, for verifying the MLM(s) 106, and/or for testing the MLM(s) 106. In one or more embodiments, the dataset(s) 410 may be applied to the MLM(s) 106 over a number of the iterations of the process 400. In one or more embodiments, the dataset 410 may represent one or more samples applied to the MLM(s) 106 by the training engine 404 in the process 400.

The output analyzer 408 of the training engine 404 may be configured to generate the loss function data 414 from the output data 412. The output data 412 may represent one or more outputs from one or more of the MLM(s) 106. In at least one embodiment, the output data 412 may include at least a portion of tensor data (and/or vector data, and/or scalar data) from one or more of the MLMs 106. The output analyzer 408 may generate the loss function data 414 based at least on analyzing the output data 412. The analysis of the output data 412 may be performed using various approaches. In at least one embodiment, the output analyzer 408 may post process at least some of the output data 412, for example, to determine one or more inferred or predicted outputs of one or more of the MLMs 106 (e.g., one or more outputs the MLM 106 is trained to or is being trained to infer). The output analyzer 408 may analyze the post processed data to determine the loss function data 414. For example, the output analyzer 408 may include one or more optimizers or solvers that the training engine 404 may use to define how to change the parameters of one or more of the MLM(s) 106—such as weights and learning rate—in order to reduce loses according to a loss or cost function(s).

The parameter adjuster 406 may be configured to generate one or more outputs, such as the update data 416 from the loss function data 414. For example, the parameter adjuster 406 may use the gradients computed using the output analyzer 408 to determine updated values of one or more parameters for one or more of the MLM(s) 106.

In one or more embodiments, the parameter adjuster 406 may be configured to enforce losses on multiple levels of the MLM(s) 106. In the example of FIG. 3, the one or more values predicted by the individual subset analyzers 304 may be enforced to match the final ground truth values for the output data 314. In one or more embodiments or in a further embodiments, the final values produced by the final layer NN are constrained to be as close as possible to the ground truth values. In one or more embodiments, L1 or MSE losses computed by the output analyzer 408 may be applied to constrain each estimated value to be proximate to its ground truth.

The techniques disclosed herein may be incorporated in any processor that may be used for processing a neural network, such as, for example, a central processing unit (CPU), a GPU, an intelligence processing unit (IPU), neural processing unit (NPU), tensor processing unit (TPU), a neural network processor (NNP), a data processing unit (DPU), a vision processing unit (VPU), an application-specific integrated circuit (ASIC), a field-programmable gate array (FPGA), and the like. Such a processor may be incorporated in a personal computer (e.g., a laptop), at a data center, in an Internet of Things (IoT) device, a handheld device (e.g., smartphone), a vehicle, a robot, a voice-controlled device, or any other device that performs inference, training or any other processing of a neural network. Such a processor may be employed in a virtualized system such that an operating system executing in a virtual machine on the system can utilize the processor.

As an example, a processor incorporating the techniques disclosed herein can be employed to process one or more neural networks in a machine to identify, classify, manipulate, handle, operate, modify, or navigate around physical objects in the real world. For example, such a processor may be employed in an autonomous vehicle (e.g., an automobile, motorcycle, helicopter, drone, plane, boat, submarine, delivery robot, etc.) to move the vehicle through the real world. Additionally, such a processor may be employed in a robot at a factory to select components and assemble components into an assembly. In at least one embodiment, a processor may be employed to implement an autonomous agent (e.g., a robot) that works along with humans and is able to understand the facial expressions and emotions of the human that it is working alongside with based at least on the output data 114 and perform one or more operations based on that understanding.

As an example, a processor incorporating the techniques disclosed herein can be employed to process one or more neural networks to identify one or more features in an image or alter, generate, or compress an image. For example, such a processor may be employed to enhance an image that is rendered using raster, ray-tracing (e.g., using NVIDIA RTX), and/or other rendering techniques. In another example, such a processor may be employed to reduce the amount of image data that is transmitted over a network (e.g., the Internet, a mobile telecommunications network, a WIFI network, as well as any other wired or wireless networking system) from a rendering device to a display device. Such transmissions may be used to stream image data from a server or a data center in the cloud to a user device (e.g., a personal computer, video game console, smartphone, other mobile devices, etc.) to enhance services that stream images such as NVIDIA GeForce Now (GFN), and the like.

As an example, a processor incorporating the techniques disclosed herein can be employed to process one or more neural networks for any other types of applications that can take advantage of a neural network. For example, such applications may involve translating languages, identifying and negating sounds in audio, detecting anomalies or defects during the production of goods and services, surveillance of living beings and non-living things, medical diagnosis, making decisions, and the like.

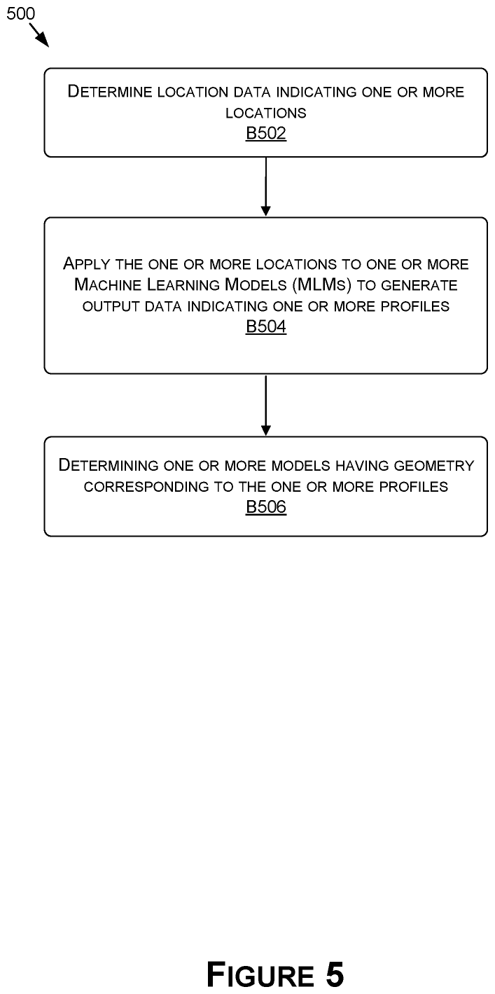

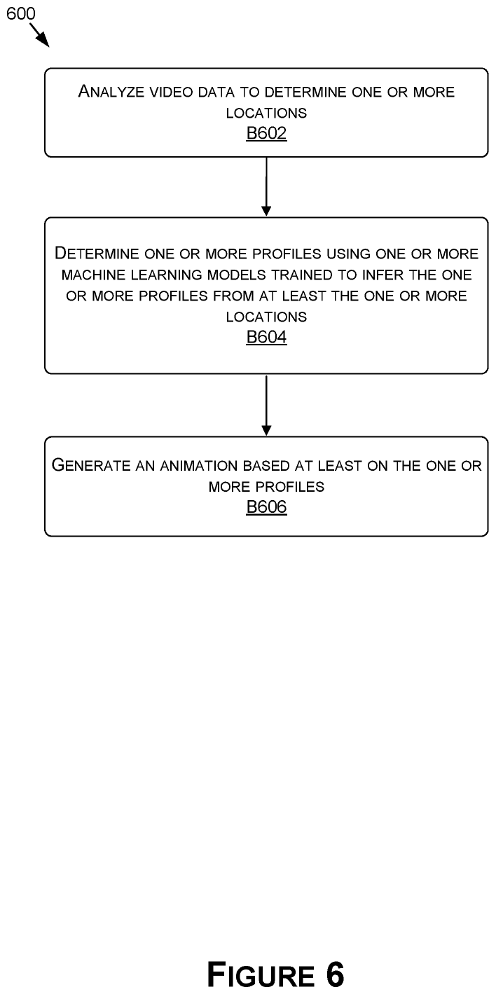

Now referring to FIGS. 5-6, each block of methods 500 and 600, and other methods described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods are described, by way of example, with respect to particular figures. However, the methods may additionally or alternatively be executed by any one system, or any combination of systems, including, but not limited to, those described herein.

FIG. 5 is a flow diagram showing a method 500 for estimating facial expressions using facial landmarks to determine one or more models, in accordance with some embodiments of the present disclosure. The method 500, at block B502, includes determining location data indicating one or more locations. For example, the landmark detector(s) 102 may determine, using image data representing the image(s) 122 depicting the face(s) 132, the location data 124 indicating one or more locations of one or more facial landmarks corresponding to the face(s) 132.

At block B504, the method 500 includes applying the one or more locations to one or more MLMs to generate output data indicating one or more profiles. For example, the location data 124 may be used to apply the one or more locations of the one or more facial landmarks to the MLM(s) 106 to generate the output data 114 indicating one or more profiles corresponding to one or more facial expressions.

At block B506, the method 500 includes determining, using the output data, one or more models having geometry corresponding to the one or more profiles. For example, the model manager 108 may determine, using the output data 114, the model(s) 130 having geometry corresponding to the one or more profiles.

Referring now to FIG. 6, FIG. 6 is a flow diagram showing a method 600 for estimating facial expressions from video data using facial landmarks to animate one or more models, in accordance with some embodiments of the present disclosure. The method 600, at block B602, includes analyzing video data to determine one or more locations. For example, the landmark detector(s) 102 may analyze video data representative of one or more sequences of images, including the image(s) 122 depicting the face(s) 132 to determine one or more locations of one or more facial landmarks corresponding to the face(s) 132.

At block B604, the method 600 includes determining one or more profiles using one or more machine learning models (MLMs) trained to infer the one or more profiles from at least the one or more locations. For example, based at least on the analyzing, one or more profiles corresponding to one or more facial expressions may be determined using the MLM(s) 106 trained to infer the one or more profiles from at least the one or more locations.

At block B606, the method 600 includes generating an animation based at least on the one or more profiles corresponding to the one or more facial expressions. For example, the model manager 108 may generate an animation of the model(s) 130 based at least on the one or more profiles corresponding to the one or more facial expressions.

### Example Computing Device

FIG. 7 is a block diagram of an example computing device(s) 700 suitable for use in implementing some embodiments of the present disclosure. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). In other words, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that enable the computing device 700 to communicate with other computing devices via an electronic communication network, included wired and/or wireless communications. The communication interface 710 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O ports 712 may enable the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may be include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that enable detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to enable the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

### Example Data Center

FIG. 8 illustrates an example data center 800 that may be used in at least one embodiments of the present disclosure. The data center 800 may include a data center infrastructure layer 810, a framework layer 820, a software layer 830, and/or an application layer 840.

As shown in FIG. 8, the data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 816(1)-816(N) may correspond to a server having one or more of the above-mentioned computing resources. In addition, in some embodiments, the node C.R.s 816(1)-8161(N) may include one or more virtual components, such as vGPUs, vCPUs, and/or the like, and/or one or more of the node C.R.s 816(1)-816(N) may correspond to a virtual machine (VM).

In at least one embodiment, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory or storage resources that may be configured or allocated to support one or more workloads. In at least one embodiment, several node C.R.s 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-816(N) and/or grouped computing resources 814. In at least one embodiment, resource orchestrator 812 may include a software design infrastructure (SDI) management entity for the data center 800. The resource orchestrator 812 may include hardware, software, or some combination thereof.

In at least one embodiment, as shown in FIG. 8, framework layer 820 may include a job scheduler 828, a configuration manager 834, a resource manager 836, and/or a distributed file system 838. The framework layer 820 may include a framework to support software 832 of software layer 830 and/or one or more application(s) 842 of application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may utilize distributed file system 838 for large-scale data processing (e.g., “big data”). In at least one embodiment, job scheduler 828 may include a Spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 828. In at least one embodiment, clustered or grouped computing resources may include grouped computing resource 814 at data center infrastructure layer 810. The resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 800. In at least one embodiment, trained or deployed machine learning models corresponding to one or more neural networks may be used to infer or predict information using resources described above with respect to the data center 800 by using weight parameters calculated through one or more training techniques, such as but not limited to those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e.g., each device may include similar components, features, and/or functionality of the computing device(s) 700. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
determining, using image data representing one or more images depicting one or more faces, location data indicating one or more locations of one or more facial landmarks corresponding to the one or more faces;
applying, using the location data, the one or more locations of the one or more facial landmarks to one or more machine learning models (MLMs) to generate output data indicating one or more profiles corresponding to one or more facial expressions; and
determining, using the output data, one or more models having geometry corresponding to the one or more profiles.

2. The method of claim 1, further comprising generating an animation using the one or more models having the geometry corresponding to the one or more profiles.

3. The method of claim 1, further comprising normalizing the one or more locations prior to the applying the one or more locations to the one or more MLMs, wherein the normalizing includes at least one of:
centering the one or more locations with respect to a coordinate system;
rotating the one or more locations with respect to the coordinate system; or
scaling the one or more locations with respect to the coordinate system.

4. The method of claim 1, wherein the one or more profiles and the one or more facial expressions correspond to a facial action coding system (FACS).

5. The method of claim 1, wherein the one or more profiles include, for at least one facial expression of the one or more facial expressions, a representation corresponding to an intensity with respect to the at least one facial expression, and the geometry is based at least on the intensity with respect to the at least one facial expression.

6. The method of claim 1, wherein the one or more MLMs include:
one or more first neural network layers to process a first subset of the one or more locations in parallel with one or more second neural network layers of the one or more MLMs processing the second subset of the one or more locations; and
one or more third neural network layers to process a first output of the one or more first neural network layers, a second output of the one or more second neural network layers, the first subset of the one or more locations, and the second subset of the one or more locations.

7. The method of claim 6, wherein the first output indicates at least one profile corresponding to at least one facial expression for a first region of a face of the one or more faces and the second output indicates at least one profile corresponding to at least one facial expression for a second region of the face.

8. The method of claim 7, wherein the first region partially overlaps with the second region.

9. The method of claim 6, wherein the one or more MLMs are trained using a first loss function corresponding to the first output and the second output, and a second loss function corresponding to a third output of the one or more third neural network layers.

10. The method of claim 1, wherein the one or more profiles corresponding to the one or more facial expressions include one or more of:
one or more identity coefficients for at least one face of the one or more faces; or
one or more expression coefficients for the at least one face.

11. A system comprising:
one or more processing units to perform operations including:
analyzing video data representative of one or more sequences of images depicting one or more faces to determine one or more locations of one or more facial landmarks corresponding to the one or more faces;
based at least on the analyzing, determining one or more profiles corresponding to one or more facial expressions using one or more machine learning models (MLMs) trained to infer the one or more profiles from at least the one or more locations; and
generating an animation of one or more models based at least on the one or more profiles corresponding to the one or more facial expressions.

12. The system of claim 11, wherein the one or more profiles indicate for at least one first image of the images one or more first intensity values for at least one facial expression of the one or more facial expressions and one or more second intensity values for the at least one facial expression, and wherein the animating the one or more models is based at least on the one or more first intensity values and the one or more second intensity values.

13. The system of claim 11, wherein the options further include normalizing the one or more locations prior to the using the one or more MLMs, wherein the normalizing includes at least one of:
centering the one or more locations with respect to a coordinate system;
rotating the one or more locations with respect to the coordinate system; or
scaling the one or more locations with respect to the coordinate system.

14. The system of claim 11, wherein the one or more MLMs include:
one or more first neural network layers to process a first subset of the one or more locations in parallel with one or more second neural network layers of the one or more MLMs processing the second subset of the one or more locations; and
one or more third neural network layers to process a first output of the one or more first neural network layers, a second output of the one or more second neural network layers, the first subset of the one or more locations, and the second subset of the one or more locations.

15. The system of claim 14, wherein the first output indicates at least one profile corresponding to at least one facial expression for a first region of a face of the one or more faces and the second output indicates at least one profile corresponding to at least one facial expression for a second region of the face.

16. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

17. A processor comprising:
one or more circuits to determine one or more models corresponding to one or more profiles corresponding to one or more facial expressions based at least on determining one or more locations of one or more facial landmarks corresponding to one or more faces depicted in one or more images and applying the one or more locations to one or more machine learning models (MLMs) to generate output data indicating the one or more profiles.

18. The processor of claim 17, wherein the one or more circuits are further to generate an animation using the one or more models corresponding to the one or more profiles.

19. The processor of clam 17, wherein the one or more circuits are further to normalize the one or more locations prior to the applying the one or more locations to the one or more MLMs, wherein the normalizing includes at least one of:
centering the one or more locations with respect to a coordinate system;
rotating the one or more locations with respect to the coordinate system; or
scaling the one or more locations with respect to the coordinate system.

20. The processor of claim 17, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
